(19) United States
(12) Patent Application Publication
(10) Pub. No.: US 2013/0041735 A1
(43) Pub. Date: Feb. 14, 2013

(54) SYSTEMS AND METHODS OF ONLINE MARKETING TO FACILITATE LIVE SOCIAL NETWORKING

(71) Applicants: William Andrew Johnson, Salt Lake City, UT (US); Ted Charles Peterson, Salt Lake City, UT (US)

(72) Inventors: William Andrew Johnson, Salt Lake City, UT (US); Ted Charles Peterson, Salt Lake City, UT (US)

(73) Assignee: T&A INNOVATIONS, LLC, Salt Lake City, UT (US)

(21) Appl. No.: 13/584,635

(22) Filed: Aug. 13, 2012

Related U.S. Application Data
(60) Provisional application No. 61/523,176, filed on Aug. 12, 2011.

(51) Int. Cl. G06Q 30/02; G06Q 30/06

(52) U.S. Cl. 705/14.23

(57) ABSTRACT

Systems and methods for online marketing are disclosed that facilitate live social networking. Event hosts create offers to purchase participation in an event occurring on a predetermined date, at a predetermined time, in a predetermined location. The offers may be conditional upon a minimum number of purchases being made. Event offers are presented to a user based on user profile matching event target information, such as a demographic criteria. A user indicates a commitment to purchase, if the terms of the event are met The user's social network may be notified of the user's intent to participate in the event and offers extended for the individuals in the social network matching the event target information A breakdown of buyers may be provided to potential buyers.

### CROSS-REFERENCE TO RELATED APPLICATIONS

This application claims the benefit under 35 U.S.C. §119(e) of U.S. Provisional Patent Application No. 61/523,176, entitled “SYSTEMS AND METHODS OF ONLINE MARKETING AND SOCIAL NETWORKING,” filed Aug. 12, 2011, which is hereby incorporated herein by reference in its entirety.

### COPYRIGHT NOTICE

©2011 T&A Innovations, L.L.C. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

The present disclosure provides systems and methods of online marketing.

### BRIEF DESCRIPTION OF THE DRAWINGS

FIG. 1 illustrates a flow diagram of a method of online marketing, according to one embodiment.

FIG. 2 illustrates a home page of a website for a system of online marketing, according to one embodiment.

FIG. 3 illustrates an event detail page of a website for a system of online marketing, according to one embodiment.

FIG. 4 illustrates an event checkout page of a website for a system of online marketing, according to one embodiment.

FIG. 5 illustrates an event request page of a website for a system of online marketing, according to one embodiment.

FIG. 6 illustrates a diagram of a system of online marketing, according to one embodiment.

### DETAILED DESCRIPTION OF PREFERRED EMBODIMENTS

The present disclosure provides systems and methods for online marketing that may facilitate live social networking. A social network is a social structure made up of individuals (or organizations), sometimes referred to as “nodes,” which are connected by one or more specific types of interdependency, including but not limited to friendship, kinship, common interest, financial exchange, or relationships of beliefs, knowledge or prestige. A social networking system may be a computer-implemented system configured to track associations or relationships among individuals by mapping or tracking associations between user profiles of users of the social networking system.

The embodiments of the present disclosure may facilitate live social networking by promoting physical gathering of groups of individuals. The gatherings may be in locales anywhere in the world. The gatherings may be promoted by online marketing to generate demand aggregation by presenting opportunities for individuals to gather as groups of people to engage in activities they may already enjoy at a discounted price through volume purchasing. The systems and methods of the present disclosure may enable an event host, such as a venue or other establishment (e.g., a seller), to communicate an offer to participate in an event (e.g., a particular activity beginning on a specific day at a specific time and at a specific location). An event may broadly encompass any gathering of two or more people at a predetermined time of day (or during a predetermined time period), on a predetermined date, and at a predetermined location. The event offer may be targeted to a specific demographic, such as single adults. Specifically, an event host can promote and offer a discounted ticket or product that the targeted demographic, such as singles ranging from the age of 18 to 35, can purchase for participation in an event set to be held on a specific day and beginning at a specific time and at a specific location. The purchases of participation in the event by individuals of the targeted demographic may result in actual participation of the individuals in real experiences with real people. Furthermore, the offering and hosting of an event via the disclosed embodiments may promote the business of the host through generation of volume purchasing and targeted advertising. An electronic social mapping or network system may be used to notify other individuals that someone in their social network has purchased participation in the event. If the other individuals are within the target demographic, an event offer may be presented to the other individuals.

A system according to one embodiment of the present disclosure may control a listing of offers of events sponsored by one or more hosts. Whether an offer of an event is presented to a given potential buyer (e.g., a viewer, an individual of a targeted demographic) may be based on demographic information or other criteria of a potential buyer, such as for example the event's proximity to the potential buyer's location. Whether an offer of an event is presented may also be based on a specified promotion launch date, a specified promotion close date, and/or as limited by a specified maximum threshold that may be established by the host. The system may also keep track of purchases of a given offer to purchase participation in an event in order to validate a sale once a specified triggering threshold number of purchases of the given offer is met. When the triggering threshold is met, the system may complete the purchase transactions and transfer of currency between the buyer and the host. The system may allow hosting and/or listing of multiple events (as many events as are available at any given time) and may allow an opportunity for the listing of events to be searched by keyword, date, and location. The system may also allow both sellers (e.g., potential hosts) or potential buyers an opportunity to recommend events anywhere in the world.

A submission of an offer to host an event may include a “name of the event or activity”, a “contact name”, a “contact number,” an “email address” of a manager or a key decision maker (e.g., a person responsible for and/or with authority to host the event), and a “date of the event.” Also, a description, threshold, and pricing, quota requirements, costs of goods or services, and other pertinent details may be included in the submission.

Buyers

The systems and methods of the present disclosure may allow users to create an account and/or profile on the system (or may interface with user profiles of a separate social networking system), which may facilitate communication of event offers to the user and provide the user an opportunity to purchase admittance to engage in participation of a hosted event. The system may facilitate transactions to allow users to become buyers by paying the purchase price. If a buyer chooses to purchase admittance to a given event, the buyer may provide payment information via the system. An actual transaction may not be completed by the system until the specified triggering threshold (e.g., number of buyers) is reached and/or exceeded. Once an event is triggered (e.g., initiated) then a payment transaction may be initiated for each buyer using the payment information provided and the buyer is required to pay for the event. As can be appreciated, in some instances a purchase price for an event may be nothing (e.g., admittance may be free). The buyer's gender and age may be stored in a profile or otherwise in association with the buyer's account and may also be retrieved and viewable by other users to convey limited information regarding other buyers. In some embodiments, the user's profile may be stored in and/or integrated with a separate social networking system (e.g., a third party system such as Facebook®, LinkedIn®, Google+®, and the like). The embodiments may also allow buyers to recommend an event that could be offered on the system by submitting information that may allow recording the suggestions and/or conveying the suggestions to hosts that may create offers to host such events.

Hosts

The systems and methods may allow hosts (e.g., sellers of events) to offer and promote an event to be hosted beginning on a specific day and at a specific time and at a specific location. An event price may be determined and advertised as a specified discount to the buyer. As can be appreciated, in some instances the event may be free. The host agrees to terms that provide a specified price to the buyer less a specified percentage that may be retained by a system of the present disclosure as a fee. Alternatively, the host may pay a fee to offer and promote an event through a system. The host may be able to determine a minimum number of buyers required for the event to be triggered and become a real event (e.g., set a triggering threshold). The host may also be able to provide a cap on the number of buyers allowed to participate in the event (e.g., set a maximum threshold). Once the triggering threshold is met, the system may initiate a purchase transaction to charge the buyers and then transfer the money to the host. In one embodiment, the money may be transferred directly to a host bank account. Promotional coupons or unique codes may also be sent out by a host via email. The coupons may include a coupon number (or event participation code), which may allow the event host to validate the purchase of participation in the event and prevent duplication of coupons. A listing of the dispersed coupons and the names of the individuals receiving them may be sent to the host that provided the coupons. For larger and/or ticketed events, the systems and methods may include coordination of tickets. For example, tickets may be mailed out to buyers or held at will call.

In the figures, a LingerLoop embodiment of the disclosed systems and methods is illustrated. A person having ordinary skill in the art appreciates that other embodiments are possible and the disclosure is not limited to the embodiments depicted, including the LingerLoop embodiment. The term LingerLoop may be used herein to refer to a system, according to one embodiment of the present disclosure.

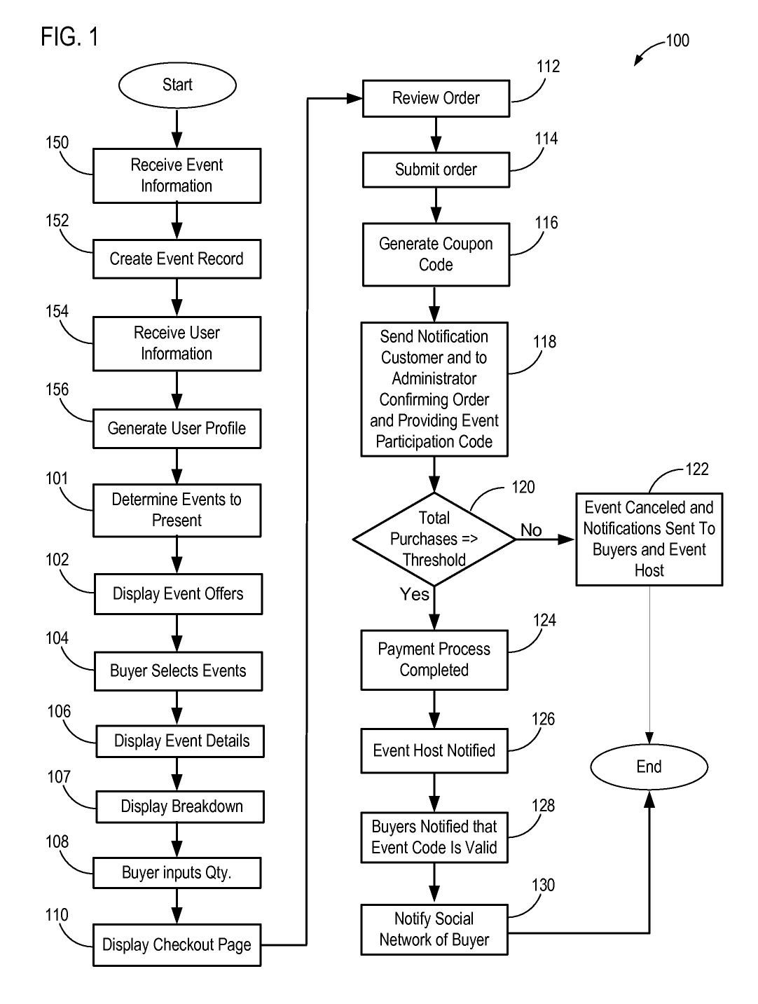

FIG. 1 illustrates a flow diagram 100 of a method of online marketing to facilitate live social networking, according to the present disclosure. Event information may be received 150, such as from an event host, and an event record may be created 152. The event information may include an event date, event time, and event location, each of which may be predetermined by the event host. User information may be received 154, such as from an individual user. The user information received 154 may be used to generate 156 a user profile. The user information may include demographic information, user preferences and/or interests, contact information, and current location information.

A system may determine 101 a set of events for which event offers may be communicated to a user of the system (e.g., a user on a remote client computing device) based on a user profile of the user. The user profile may be stored by a social networking system. The social networking system may be a part of the system or may be a separate social networking system interfaced by the system. The user profile may comprise information about the user. The information about the user may include demographic information. The system may determine 101 the set of events based on a target demographic of the event and based on demographic information included in the user profile of the user of the system.

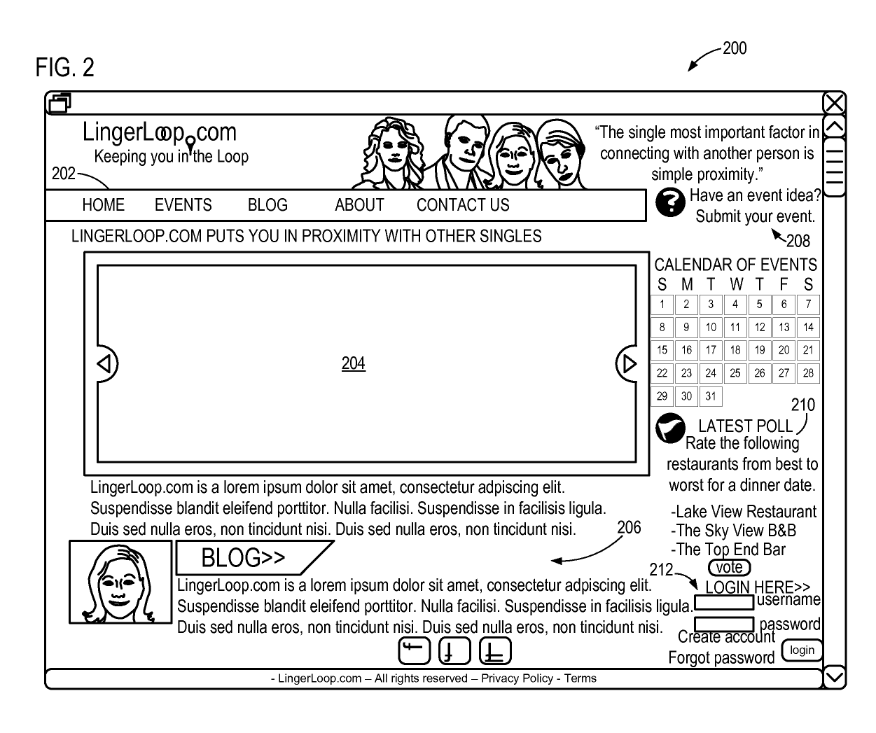

The system may display 102 (e.g., on a remote client computing device) or otherwise communicate one or more event offers, such as event offers for the one or more events determined based on the profile of the user. For example, a website home page may present a slide show of one or more event offers. An event offer may be an offer to purchase participation in an event. The slide show may begin with a newest added event offer and cascade through a plurality of open event offers for a given locale (or specified geographic area). One embodiment of a website home page is illustrated in FIG. 2 and described below with reference to the same.

The user may desire to participate in an event and may select an event offer that may be presented, such as on a user interface rendered on a display screen. The system may receive a user selection of an event offer. For example, a user may select an event offer 104 by clicking on an event offer, or an advertisement or other representation of the event (e.g., a link, a user control) in the slide show.

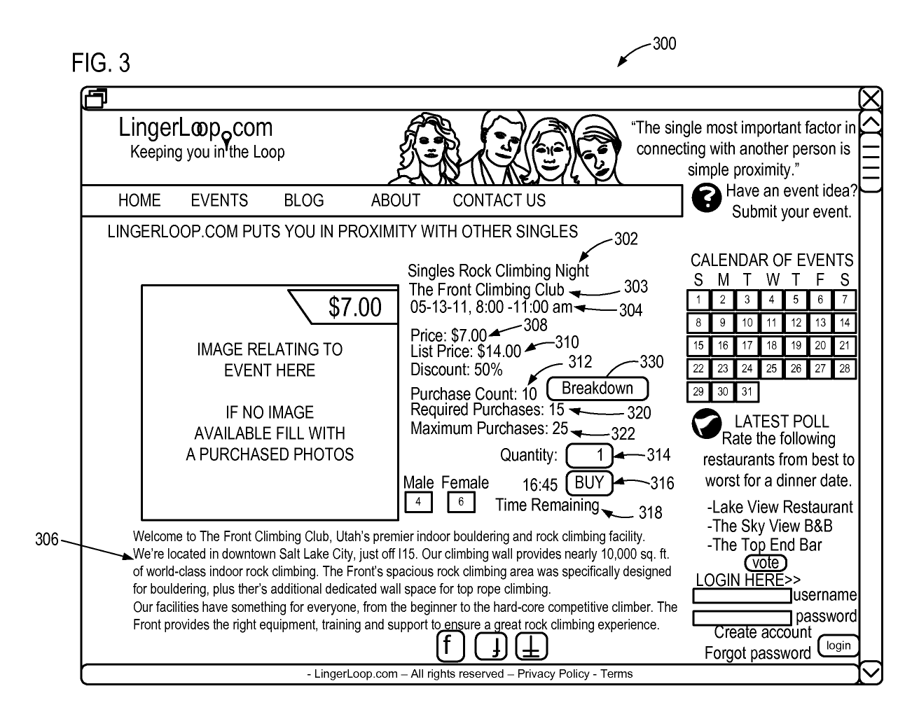

Event details may be displayed 106 for a selected event offer, including a beginning date and a starting time of the event, a clock displaying a time remaining until termination of the event offer, a triggering threshold number of buyers to trigger the event and make it “live,” a maximum threshold number of buyers, a purchase price for admittance to and/or participation in the event, and a number of presently committed buyers (e.g., a quantity of purchases of the offer that have already been made). A webpage displaying event details is illustrated in FIG. 3 and described below with reference to the same.

A breakdown of a total number of purchases of the event may be displayed 107. For example, the breakdown displayed 107 may be based on demographics, for example, to indicate the number of purchases of the event based on gender, location, age, occupation, or other demographic criterion. The breakdown may be based on other information, such as a date or time period in which the purchase was made, buyer preferences/interests, number of purchases made per buyer (e.g., buyers making two purchases of the event may indicate the buyer is attending the event with a significant other, buyers making more than two purchases of the event may indicate a group attending the event), buyer affiliations, buyers in the present user's social network, and the like.

A user purchasing participation in the selected event (e.g., a buyer) may be enabled to input 108 a desired quantity of events to be purchased. The buyer (i.e., the user) may enter an amount or quantity to purchase for the selected event and the system may receive the input. The quantity may be limited, for example, if the quantity surpasses the maximum threshold or if there is a maximum purchase restriction. The purchase may be submitted by clicking on a “Submit Button,” for example.

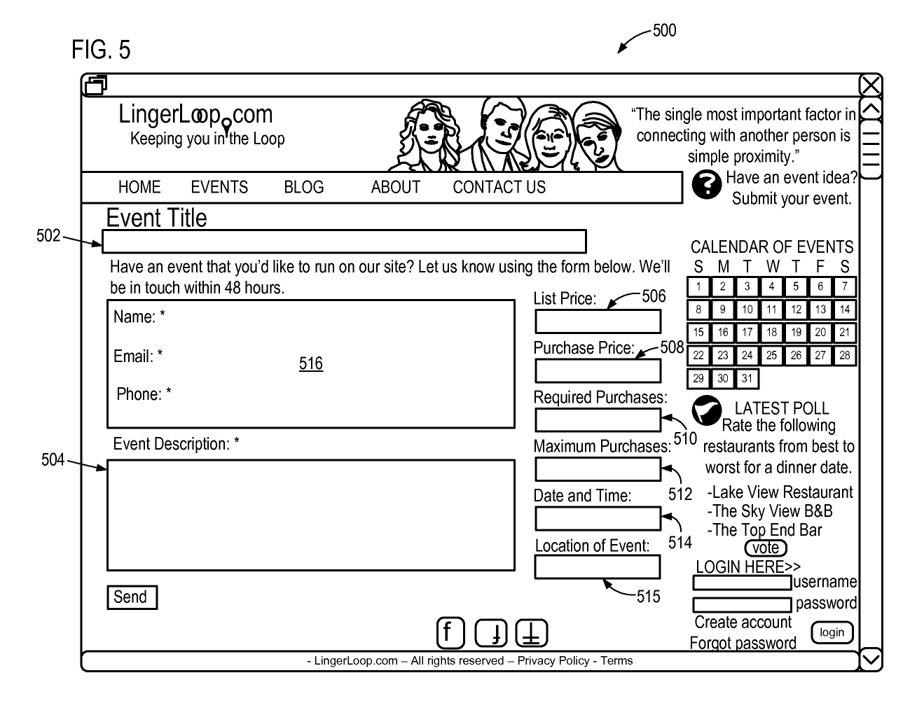

After submission, a system checkout page may be displayed 110 showing, for example, contents of an electronic shopping cart. The contents of the electronic cart may include a quantity, title and/or description or caption of an event, a purchase price, an email address of the buyer, and fields for entering purchase transaction information (e.g., credit card information, PayPal® account, billing information, and/or the like). A system checkout webpage is illustrated in FIG. 5 and described below with reference to the same.

The buyer may be given an opportunity to review the order 112 by clicking an input, such as a “Review Order” button. The buyer may be given an opportunity to review and edit the order before submission. The system may generate a representation or summary of the order for review. The representation or summary of the order may be displayed for the buyer to review, including the Event details and the amount that will be billed to the buyer's credit card.

The buyer may submit 114 the order, for example, by clicking a “Submit” button to complete the order. If all the information is accurate and the order is still desired, the buyer may click on the “Submit” button to complete the order.

A unique event participation code may be generated 116 for each purchase of participation. The event participation code (or coupon code) can be sent to the buyer. The event participation code may provide evidence of actual purchase of participation in the event. The event participation code may be used like a ticket to gain admission/access to the event. In some embodiments, the event participation code may be embodied in a printed/printable ticket.

A notification, such as an electronic communication (e.g., email, text) may be sent 118 to the buyer and/or to a system administrator confirming the order and providing the event participation code for each event purchased. The notification may provide an event participation code for each purchased event.

The quantities purchased may be added to a purchase count tracking a total number of purchases for the event. The total number of purchases (or purchase count) may be compared 120 to a triggering threshold to determine if the required number of buyers is met. Each event offer may be dependent (e.g., conditional) on a minimum number of purchases for the specific event—i.e., a triggering threshold. If the minimum number of purchases (triggering threshold) is met, as determined by the system and/or the event host, the event may become “live.” If the event does not have the minimum purchases required for the event (i.e., the triggering threshold is not met) by the purchase deadline then the event may be cancelled 122. If the event 122 is cancelled, a payment process for each buyer of the event may be cancelled as well, or otherwise not processed and/or completed. If the event is cancelled 122, for example, because the triggering threshold is not met, notifications may be sent to the buyers and/or the event host. For example, emails may be sent to the buyer and the event host that the event has been cancelled. Event codes that may have been distributed to buyers may be voided. The notifications sent may indicate that the event codes provided are void (e.g., not valid).

If the event goes “live” (e.g., the triggering threshold is met), a payment process may be completed 124 for each buyer. Once the minimum number of events is purchased, then the payment process is completed for all purchases already made for the event and any future purchases for the event up until the maximum threshold is reached, as determined by the system and/or the event host.

If the event goes live, the event host may be notified 126 and provided with a listing of the buyers with the corresponding event codes. For example, upon completion of the time period for purchasing participation in the event and/or completion of the payment process for each of the buyers, the event host may be notified with a listing of the buyers and the corresponding codes.

The buyers may also be notified 128 that the payment process for the purchase of participation in the event has occurred or otherwise been completed. For example, the buyers may be notified 128 that the event code received is valid. Once the event being displayed is timed out for purchasing and the payment process is completed for the buyers, the buyers may be notified through an email that the event code is now valid for use at the associated event.

The system may also notify 130 the social network of the buyer, for example, to notify additional individuals having user profiles associated with the buyer, such as via a social network system, that the buyer has purchased participation in the event. The notification to each of the additional individuals may also include an event offer to purchase participation in the event, if the additional individual(s) match the target demographic, such as if the user profile(s) of the additional individual(s) has demographic information matching the target demographic for the event.

Then the method 100 may end.

FIG. 2 illustrates a home page 200 of a website for a system of online marketing to facilitate social networking, according to one embodiment. The home page 200 may consist of a site bar 202, a slideshow of events 204, a blog introduction 206, an event suggestion link 208, a poll section 210, and a login area 212.

The site bar 202 may provide links to the various pages of the site including, “Home” page, “Events” page, “Blog” page, “Contact” page and “About” page.

The slideshow of events 204 may display a slideshow that presents or shows an advertisement, information, or other representation of a listing of events in a given area and/or that are pertinent to a user viewing the page. For example, the most recently listed event may be shown first and then the slide show may cascade through any remaining events that are still open for purchase and/or that have not expired during the time limit set. Thus, the user may be able to view information about each open event during the course of the slide show. The displayed representations of the events may include a link that may provide access to a more detailed view of the event and an option (e.g., user interface controls) for purchase of the event. An event detail page is illustrated in FIG. 3 and discussed below with reference to the same.

The blog introduction 206 may provide a title and the first few sentences of a featured blog article. Users may be able to click on the blog introduction 206 or a blog tab in the site bar to go to a blog page where the full article can be viewed and where users can submit their own thoughts, ideas, illustrations, experiences, etc.

The event suggestion link 208 may allow users to submit an event idea and appropriate information to allow the system administrators to contact the event host and coordinate an event. A user suggesting an event is illustrated in FIG. 5 and described more fully below with reference to the same.

The poll section 210 may allow users to vote on a topic or survey that is currently active. The poll section 210 may display an active poll and provide input components to allow users to cast a vote in the poll.

The login area 212 may provide input components for users who want to login to the system website. In one embodiment, logging in may allow a user to benefit from additional features of the system.

FIG. 3 illustrates an event detail page 300 of a website for a system of online marketing and social networking, according to one embodiment. The event detail page 300 may be displayed by the system after a user clicks on a featured event. The event detail page 300 may include a title of the event 302, an event location 303, a beginning date and time of event 304, a description of the event 306, a purchase price 308 to participate in the event, a list price 310, a purchase count 312, a quantity text field to enter the quantity to purchase 314, a “Buy” button 316, a time remaining clock 318, a required number of purchases field 320, a maximum quantity field 322, and a breakdown button 330.

The title of the event 302 may indicate to users a title of the event for which event details are being displayed (viewed) on the event detail page 300.

The event location 303 indicates where the event will occur. The location is predetermined, generally by the host, to provide a venue to facilitate live social networking during the event.

The beginning date and time 304 may display the beginning date and time period of the event. The date and time 304 indicates to users when the event will occur to facilitate live social networking.

The description of the event 306 may provide information regarding the event, such as a product or service that may be available during the event and that may be included with the purchase of participation in the event. The information may also include, for example, performers, venue, parking information, and the like. The description of the event 306 may also provide restrictions that may be associated with the purchase.

The purchase price 308 may provide the user with a cost of the event and the amount that would be charged for one purchase of participation in the displayed event if the event goes live (e.g., is triggered). If a minimum number of purchases of participation in the event are made, generally as determined by the host, the event goes live and the buyers—those who indicated a commitment to purchase participation in the event if the event goes live—are charged for purchase of participation in the event.

The list price 310 may indicate what the original value of the event is and thereby help a user know what discount is being offered by the event offer.

The purchase count 312 may indicate a current quantity of purchases. In one embodiment, the purchase count may be broken down based on demographics specified by the user. A user may, for example, be able to click on the purchase count and/or the breakdown button 330 and another page may display for providing demographic information about the purchasers who have contributed to the purchase count. For example, the purchase count may be broken down into number of male buyers and number of female buyers. In another embodiment, the purchase count may be broken down based on age or age range of the buyers. In other embodiments, the purchase count may be broken down based on other demographic criteria, including but not limited to buyers' home town, current location (e.g., city or metro area), religious affiliation, race, marital status (e.g., single, divorced, etc.) In another embodiment, the purchase count may be broken down based on occupation of the buyers. As can be appreciated, one or more demographic criteria may be applied, such that a user could identify, for example, the number of twenty-eight year-old female accountants who have purchased participation in the event. The demographic criteria may be obtained from an account or profile created by the buyer on the system. Enabling a user to view the demographic information of the buyers that is of interest to the user may offer incentive, or disincentive, for the user to purchase participation in the event. When a user is deciding whether to purchase and/or attend an event, often times the attraction of the event is affected by the number of people planning to attend the event. For example, if an event is targeted at the single adults, that demographic may have incentive to be in locations at the same time as other single adults to provide opportunity for meeting more people with their similar interests and personal situations. A user deciding whether the cost of the event is worth attending can weigh that decision on the number of people that are tied to the purchase of that event.

In still another embodiment, the user may be able to view profile pages for each buyer committed to purchase participation in an event. For example, the user may be able to click a link to view a user profile of a buyer stored in the system. In another embodiment, the user may be able to view a profile page of a buyer on an external social networking site, such as Facebook®, LinkedIn®, Google+®, and the like. A user may be able to set a preference to specify which profile page should appear to other users seeking demographic information about buyers (e.g., prospective attendees) of an event.

The quantity to purchase field 314 may provide a user a way to enter the number or quantity of the event to purchase.

The “Buy” button 316 may be provided to enable a user to start the order process prior to purchase.

The time remaining clock 318 may allow the user to know how much time is available prior to the close of a purchasing period of the displayed event.

The required purchases field 320 may display the amount (e.g., number) of purchases required to meet a triggering threshold for the event to be considered “live” or active. If the purchase count reaches the triggering threshold, the event may be scheduled to occur and the buyers may be charged for the purchases.

The maximum quantity field 322 may display a maximum number of purchases of the event the system is authorized to make at the discounted rate. When the purchase count reaches the maximum quantity threshold, the event may be closed for purchasing. In one embodiment, a closed event may remain online for viewing until the time remaining clock expires.

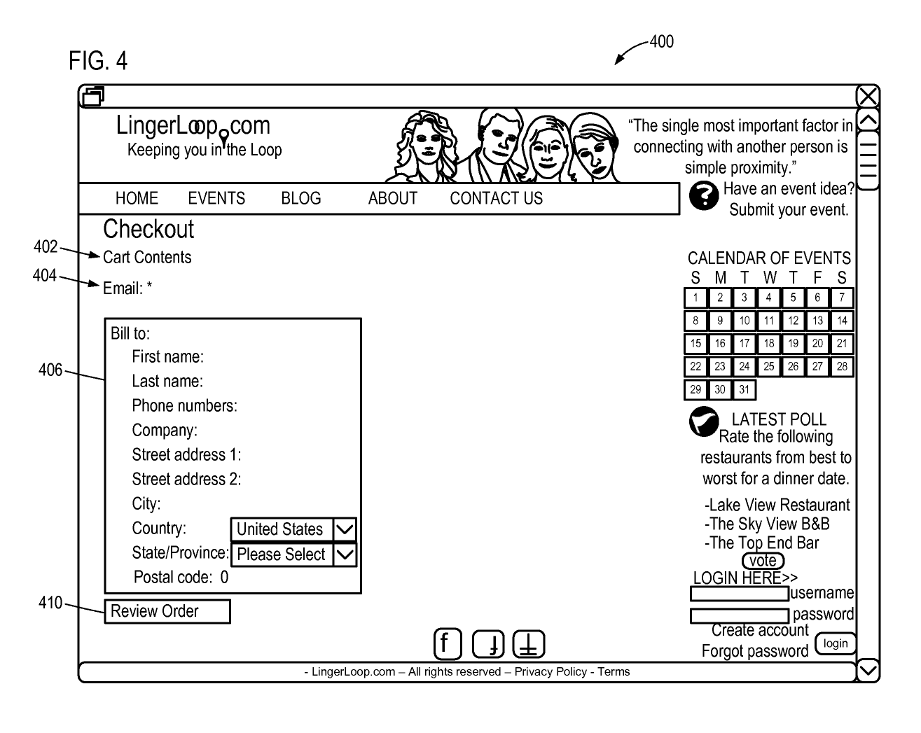

FIG. 4 illustrates an event checkout page 400 of a website for a system of online marketing and social networking, according to one embodiment. The event checkout page 400 may provide a graphical user interface of the system for purchasing a selected event. After a quantity for purchase is submitted by a user via the event detail page 300 of FIG. 3, the event checkout page may appear and indicate the cart contents 402 of an electronic shopping cart, a text field for email submission 404, a section for credit card and billing information 406, a review order button 410.

The cart contents 402 may indicate the title of the purchased events, a quantity of each event, and a total price of the purchase (e.g., a sum of the price for all events to be purchased).

The text field for email submission 404 may allow the user to enter a valid email address to obtain order verification and the redeemable code to present at the entry to the event.

The credit card and billing information section 406 may allow a user to enter credit card and billing information to facilitate the user (e.g., buyer) to be charged for the purchase once the purchased event is triggered (e.g., becomes live).

The review order button 410 may enable a user to provide user input to indicate that the user is prepared to proceed to reviewing an order to allow for completion of the order and purchase the event.

FIG. 5 illustrates an event request page 500 of a website for a system of online marketing and social networking, according to one embodiment. The event request page 500 may present a user interface with the system that may enable a user (buyer or seller) to suggest a group event. FIG. 5 shows the event request page 500 when a user clicks on the “suggest an event” area of the site, and the page 500 includes a text field for an event title 502, a text field for an event description(s) 504, a text field for a list price of the event 506, a text field for a purchase price 508, a text field for a required minimum number of purchases 510 (or a triggering number of purchases 510), a text field for a maximum number of purchases 512, a text field for a beginning date and a beginning time of the requested event 514, a text field for a location of the event 515, and a text field for contact information of a vendor representative 516.

The event title text field 502 may allow a user to suggest a title of a possible future event.

The event description text field 504 may allow the user to provide information regarding a possible future event.

The list price text field 506 may allow the user to provide the retail or list price of the event being suggested. A requesting user may be a potential host.

The purchase price text field 508 may allow the user to provide the amount being offered at the group event discounted price if the minimum threshold of purchases is met. The triggering number of purchases text field 510 may allow the user to enter the minimum threshold of purchases to acquire the group event discounted price.

The maximum number of purchases text field 512 may allow the user to enter the maximum number that may be allowed for purchase of the event.

The beginning date and beginning time of the event text field 514 may allow the user to enter a time period during which the event is occurring.

The contact information text field 516 may allow the user to enter the name, telephone, email, etc. of the vendor representative.

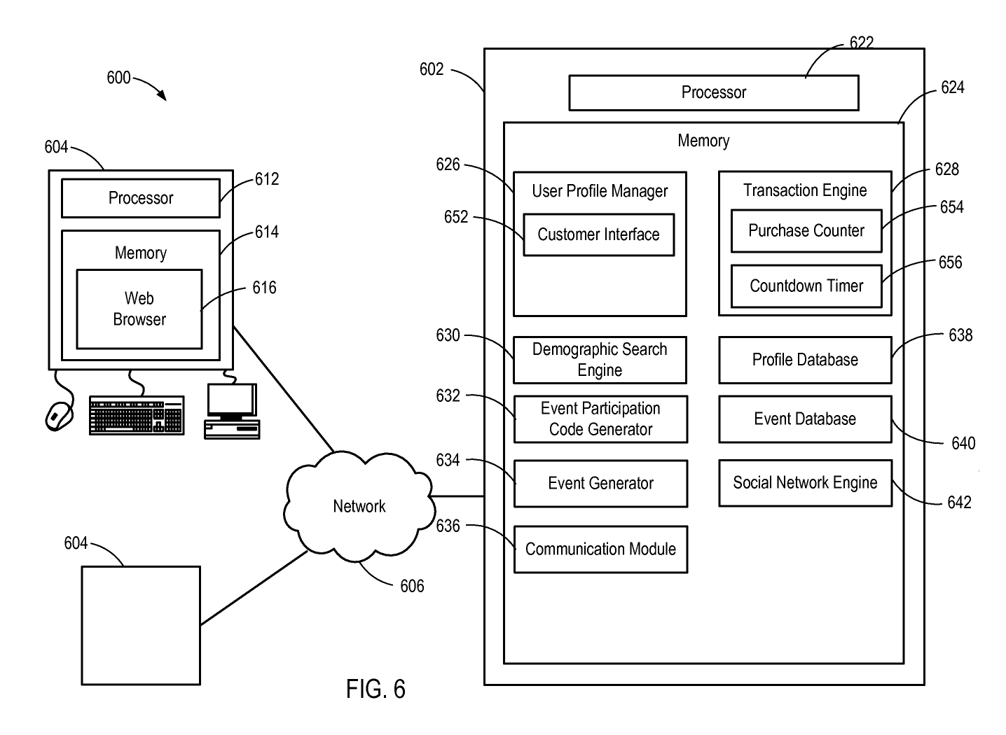

FIG. 6 illustrates a diagram of a system 600 of online marketing to facilitate live social networking, according to one embodiment. The system 600 may include a central server computing device 602 (or server) and one or more client computing devices 604 (or clients) coupled via a network 606. The client computing devices 604 may include a processor 612, a memory 614, a web browser 616, and input devices (e.g., mouse, keyboard) and output devices (e.g., display monitor).

The server computing device 602 may include a processor 622, a memory 624 in communication with the processor 622, a user profile manager 626, a transaction engine 628, a demographic search engine 630, and event participation code generator 632, an event generator 634, a communication module 636, a profile database 638, an event database 640, and a social network engine 642.

The user profile manager 626 may be configured to access user information stored in user profiles, such as user profiles stored in the profile database 638 or user profiles of one or more separate, external social network systems. The user profiles may store user information, which can be used to identify events targeted toward a demographic group in which a user of the system may be included. The user information may be collected via customer interface 652 of the user profile manager 626. The user profile manager 626 may be configured to receive user information for a user and to generate a user profile for the user based on the user information, wherein the generated user profile is stored in the memory. In another embodiment, the user profile manager 626 may be configured to interface with pre-established profiles in an external social networking system.

The demographic search engine 630 may be configured to identify event offers for events stored in the event database targeted to individuals in a particular demographic, based on received demographic criteria. The demographic search engine 630 may capture demographic information from a user profile of a user of the system and identify demographic criteria and then find events stored in the event database 640 that are targeted toward a demographic having the demographic criteria. The demographic search engine 630 may also receive demographic criteria, such as via input from a user, and perform the same search of the event database. The demographic search engine 630 may determine a set of one or more event offers to be presented to a given user of the system 600. An event offer may be an offer to purchase participation in the event, and may be stored or otherwise associated and/or included with an event record in the event database 640. The event offer may include terms of purchase and may be conditional upon a total number of purchases of participation in the event reaching a triggering threshold.

The transaction engine 628 may be configured to receive input indicating commitment of a given user to purchase participation in an event according to terms of the event offer. Upon the total number of purchases of participation in the event reaching the triggering threshold, the transaction engine 628 may be configured to complete a payment process for each buyer of participation in the event. In other words, a user may indicate a commitment to purchase the event should the conditions be met (e.g., a minimum number—i.e., a triggering threshold—of purchases of participation). The transaction engine 628 may include a purchase counter 654 configured to track a purchase count of the total number of purchases of participation in the event and to determine whether the total number of purchases is greater than or equal to the triggering threshold, the transaction engine further configured to complete a payment process for each buyer of participation in the event, including the first individual, upon the triggering threshold being met.

The transaction engine 628 may also include a countdown timer 656 configured to determine when an event offer expires.

The transaction engine 628 may be configured to break down the total number of purchases (e.g., as tracked by the purchase counter 654) based on one or more desired criteria and present the number of purchases made by buyers having the one or more desired criteria. The breakdown may be based on user information gleaned from user profiles of the buyers.

The event participation code generator 632 may be configured to create a unique event code for each purchase of participation in the event. The participation code may be used by a buyer to redeem participation in the event.

The event generator 634 may be configured to receive event information and to generate an event record that is stored in the event database 640. The event information may include an event date, an event start time, an event location, and demographic criteria of a target demographic.

The communication module 636 may be configured to send notifications to buyers of participation in the event upon completion of the purchase process to complete the transaction. The communication module 636 may also be configured to send notifications to a host advising that the event has gone live and/or providing event participation codes for each purchase of participation in the event. The communication module 636 may also send notifications to other users who may be associated with (e.g., in the social network of) each buyer and/or whose user profiles include user information matching the demographic criteria of the target demographic of the event.

The social network engine 642 may be a computer-implemented system configured to track associations or relationships among individuals by mapping or tracking associations between user profiles of users of the system 600. The social network engine 642 may be implemented on the server 602 or another computing device associated with and/or coupled to the server 602. In another embodiment, the social network engine 642 may be an independent or external third-party social networking system.

Those having ordinary skill in the art appreciate that many changes may be made to the details of the above-described embodiments without departing from the underlying principles of the invention. Various modifications, changes, and variations apparent to those of skill in the art may be made in the arrangement, operation, and details of the methods and systems of the disclosure without departing from the spirit and scope of the disclosure. For example, various operational steps, as well as components for carrying out operational steps, may be implemented in alternate ways depending upon the particular application or in consideration of any number of cost functions associated with the operation of the system, e.g., one or more of the steps may be deleted, modified, or combined with other steps. Thus, it is to be understood that the embodiments described above have been presented by way of example, and not limitation.

Additionally, as will be appreciated by one of ordinary skill in the art, principles of the present disclosure may be reflected in a computer program product on a computer-readable storage medium having computer-readable program code means embodied in the storage medium. Any suitable tangible, nontransitory computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general purpose computer, special purpose computer, or other programmable data processing apparatus to produce a machine, such that the instructions that execute on the computer or other programmable data processing apparatus create means for implementing the functions specified. These computer program instructions may also be stored in a computer-readable memory that can direct a computer or other programmable data processing apparatus to function in a particular manner, such that the instructions stored in the computer-readable memory produce an article of manufacture including implementing means which implement the function specified. The computer program instructions may also be loaded onto a computer or other programmable data processing apparatus to cause a series of operational steps to be performed on the computer or other programmable apparatus to produce a computer-implemented process, such that the instructions which execute on the computer or other programmable apparatus provide steps for implementing the functions specified.

Unless defined otherwise, all technical and scientific terms used herein have the same meaning as commonly understood by one of ordinary skill in the art to which the embodiments of the invention belong. Although any methods and materials similar or equivalent to those described herein can also be used in the practice or testing of the embodiments of the present invention, the preferred methods and materials are now describe. All patents and publications mentioned herein, including those cited in the Background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the embodiments of the present invention are not entitled to antedate such publication by virtue of prior invention. Further, the dates of publication provided may be different from the actual publication dates which may need to be independently confirmed.

It is also contemplated that various combinations or sub-combinations of the specific features and aspects of the embodiments may be made and still fall within the scope of the invention. It should be understood that various features and aspects of the disclosed embodiments can be combined with or substituted for one another in order to form varying modes of the disclosed embodiments of the present invention. Thus, it is intended that the scope of at least some of the present invention herein disclosed should not be limited by the particular disclosed embodiments described above.

Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

What is claimed is:

1. A computer-implemented method of online marketing, comprising:
receiving on a server computing device event information about an event that begins at a predetermined time, on a predetermined date, and at a predetermined location, the event information including information indicating a target demographic to which the event is targeted;
communicating to a remote client computing device an event offer to be presented to a first individual, the remote client computing device coupled to the server computing device via network, the event offer comprising an offer to purchase participation in the event, the event offer including terms of purchase and being conditional upon a total number of purchases of participation in the event reaching a triggering threshold, wherein the event offer is communicated to the remote client computing device based on a user profile of the first individual, the user profile comprising demographic information corresponding to the target demographic of the event;
receiving input from the first individual indicating a commitment to purchase participation in the event according to the terms of the event offer and upon the total number of purchases of participation in the event reaching the triggering threshold;
incrementing a purchase count of a total number of purchases of participation in the event based on the input received indicating the commitment of the first individual to purchase participation in the event; and
after the purchase count reaches the triggering threshold, completing a payment process for each buyer of participation in the event, including completing a payment process for the first individual.

2. The method of claim 1, wherein the user profile of the first individual includes location information, and wherein the event offer is communicated to the remote computing device based on proximity of the event to a location of the first individual.

3. The method of claim 1, further comprising
cancelling the event if the purchase count does not reach the triggering threshold before a cutoff deadline; and
communicating to each buyer a notification indicating that event offer is withdrawn due to the total number of purchases of participation in the event not reaching the triggering threshold.

4. The method of claim 1, further comprising:
receiving on the server computing device information about the first individual; and
generating a user profile for the first individual based on received information about the first individual.

5. The method of claim 4, further comprising
receiving on the server computing device information about a second individual;
generating a user profile for the second individual based on received information about the second individual;
receiving information from the first individual identifying the user profile of the second individual to establish a relationship between the user profile of the first individual and the user profile of the second individual; and
associating the user profile of the first individual with the user profile of the second individual.

6. The method of claim 5, further comprising:
sending an electronic communication to the second individual, the electronic communication notifying the second individual of the event, including the predetermined time, the predetermined date, and the predetermined location of the event, and notifying the second individual that the first individual committed to purchase participation in the event, subject to the total number of purchases of participation in the event reaching the triggering threshold.

7. The method of claim 6, wherein the electronic communication to a second individual further comprises an event offer, if the user profile of the second individual comprises demographic information corresponding to the target demographic of the event.

8. The method of claim 1, wherein the user profile of the first individual is generated by a computer-implemented social networking system and is associated with one or more user profiles of one or more other individuals in a social network.

9. The method of claim 1, further comprising:
sending a notification to each buyer of participation in the event, the notification providing an event participation code to evidence the purchase of participation in the event.

10. The method of claim 1, further comprising:
providing to a host of the event a listing of the buyers of participation in the event and associated event participation codes.

11. The method of claim 1, further comprising:
communicating a breakdown of the purchase count, the break down based on at least one demographic criterion.

12. The method of claim 11, wherein the demographic criterion is gender, such that the breakdown provides a number of male buyers and a number of female buyers.

13. The method of claim 1, wherein the event includes a predetermined activity occurring beginning at the predetermined time.

14. The method of claim 1, wherein the event information is received from a second remote client computing device coupled to the server computing device via the network, wherein the event information is received by the client device as input provided by a host of the event.

15. A system of online marketing, comprising:
a processor;
a memory in communication with the processor;
a user profile manager configured to access user information stored in a user profile of a first individual, the user information to identify events targeted toward a demographic group in which the first individual is included;
a demographic search engine configured to identify event offers for events targeted to demographics of the first individual and to determine a set of one or more event offers to be presented to the first individual, each event offer comprising an offer to purchase participation in the event, the event offer including terms of purchase and being conditional upon a total number of purchases of participation in the event reaching a triggering threshold;
a transaction engine configured to receive input indicating commitment of the first user to purchase participation in the event according to terms of the event offer and upon the total number of purchases of participation in the event reaching the triggering threshold, the transaction engine further configured to track a purchase count of the total number of purchases of participation in the event and to determine whether the total number of purchases is greater than or equal to the triggering threshold, the transaction engine further configured to complete a payment process for each buyer of participation in the event, including the first individual, upon the triggering threshold being met.

16. The system of claim 15, further comprising:
an event code generator configured to create a unique event code for each purchase of participation in the event, including a purchase of the first individual, wherein a first unique event code is used by the first individual to redeem participation in the event.

17. The system of claim 15, further comprising:
a communication module configured to send a notification to buyers of participation in the event, including the first individual, upon completion of the purchase process to complete the transaction.

18. The system of claim 15, wherein the a user profile manager is configured to receive user information for a user and to generate a user profile for the user based on the user information, wherein the generated user profile is stored in the memory.

19. The system of claim 15, wherein the user profile manager is configured to interface with pre-established profiles in an external social networking system.

20. The system of claim 15, further comprising:
an event generator configured to receive event information and to generate an event record, the event information including an event date, an event start time, an event location, and demographic criteria of a target demographic of customers.

21. The system of claim 15, wherein the demographic search engine is further configured to search for events having a target demographic including a received demographic criteria.

22. The system of claim 15, wherein the transaction engine is configured to breakdown the total number of purchases based on one or more desired criteria and present the number of purchases made by buyers having the one or more desired criteria, based on user profiles of the buyers.

23. A non-transitory computer-readable storage medium having stored thereon instructions that, when executed by a computing device, cause the computing device to perform operations of online marketing, the operations comprising:
receiving on a server computing device event information about an event that begins at a predetermined time, on a predetermined date, and at a predetermined location, the event information including information indicating a target demographic to which the event is targeted;
communicating to a remote client computing device an event offer to be presented to a first individual, the remote client computing device coupled to the server computing device via network, the event offer comprising an offer to purchase participation in the event, the event offer including terms of purchase and being conditional upon a total number of purchases of participation in the event reaching a triggering threshold, wherein the event offer is communicated to the remote client computing device based on a user profile of the first individual, the user profile comprising demographic information corresponding to the target demographic of the event;
receiving input from the first individual indicating a commitment to purchase participation in the event according to the terms of the event offer and upon the total number of purchases of participation in the event reaching the triggering threshold;
incrementing a purchase count of a total number of purchases of participation in the event based on the input received indicating the commitment of the first individual to purchase participation in the event; and
after the purchase count reaches the triggering threshold, completing a payment process for each buyer of participation in the event, including completing a payment process for the first individual.
